(19) United States
(12) Patent Application Publication
(10) Pub. No.: US 2004/0107129 A1
(43) Pub. Date: Jun. 3, 2004

(54) Method and system and computer program with program code means, and computer program product for evaluating an electronic object for sale in a computer network

(76) Inventor: Manfred Langen, Munchen (DE)

Correspondence Address: STAAS & HALSEY LLP, SUITE 700, 1201 NEW YORK AVENUE, N.W., WASHINGTON, DC, 20005, US

(21) Appl. No.: 10/472,063

(22) PCT Filed: Jan. 15, 2003
(86) PCT No.: PCT/DE03/00098

(30) Foreign Application Priority Data
Jan. 16, 2002 (DE) 102 01 478.7

(51) Int. Cl. G06F 17/60

(52) U.S. Cl. 705/10

(57) ABSTRACT

The invention relates to the evaluation of an electronic object for sale in a computer network. At least an availability period, indicating a period of time during which said electronic object has been for sale in the computer network, and an object count parameter, indicating how many electronic objects of the same type as the electronic object for sale have been sold in the computer network, are detected for the electronic object for sale. The evaluation is made at least depending on the availability period and the object count parameter.

Method and system and also computer program with program code means and computer program product for evaluating an electronic object for sale in a computer network

The invention relates to the evaluation of an electronic object for sale in a computer network.

As a rule it is not possible or is difficult to evaluate information and knowledge content, non-physical goods in general; according to objective criteria, by contrast with physical goods, as tradable goods of daily life.

Transferring an evaluation of a physical item, for example by determining a price or value for the physical goods based on objective market criteria, as is for example known for books from a bookseller, to non-physical goods is still possible but is not adequate.

In particular with digital goods that can be copied in any way without inherent costs, such as “downloads” in an Internet, for which there is uncertainty about the true and fair value of the goods both on the provider side and on the consumer side, approaches previously employed for evaluation are unsuitable.

Evaluation methods such as used for evaluations of companies with an evaluation method directly fed back from a market, such as evaluation by a stock market, were having to be used. These types of previously-known, oriented-oriented evaluation methods are however unsuitable for transfer to and use with digital non-physical goods that can be copied in any way without inherent costs, since on exchanges a defined, non-duplicatable quantity of the evaluated goods is traded in each case. Thus in such a case there is an offer which is defined by the availability. Market forces of supply and demand can define a current evaluation here.

With previously known, non-dynamic and static approaches to evaluation of digital goods which can be freely copied an evaluation for the goods involved, in such cases a uniform price for all purchasers, is determined as a rule for a longer period by the supplier (statically). This occurs although it is difficult, especially for the supplier, to estimate the value of such goods and the value actually changes each time such goods are sold.

Another known, dynamic evaluation method is an auction method performed via a computer network, known as an Internet auction, in which however limited volumes and physical objects are evaluated or traded.

With such Internet auctions the evaluation or the price for goods offered over the Internet is solely defined by a bidding procedure between potential purchasers. In most such cases a period for bidding as well as a reserve price for the goods to be auctioned are defined; in rare cases an evaluation by the supplier from feedback by purchasers at previous auctions is taken into consideration for evaluation or pricing in the auction process.

Newer approaches to evaluation by setting prices attempt to establish prices only once an object has been purchased, based on customer satisfaction, for example by feedback from purchasers. A danger with such approaches is that feedback from purchasers could tend to have a negative affect resulting in a price reduction.

However previous evaluation methods did not take account of the fact that the evaluations of non-physical goods, such as information and knowledge content, can fall as well as rise. No account was taken of the fact that as a rule the value of such goods falls over time. The object of the invention is thus to specify a dynamic method of evaluation for electronic objects offered for sale in a computer network which will make possible a dynamic and fair evaluation of prices for the electronic objects offered.

This object is achieved by the method and the system as well as by the computer program with program code means and the computer program product for evaluating an electronic object offered in a computer network with the features in accordance with the relevant independent patent claim.

With the method for evaluating an electronic object offered in a computer network at least the following information is determined for the electronic object offered

an offer period, which defines how long the electronic object offered has been on offer in the computer network, and

an object count parameter which defines how many objects of the same type as the offered electronic object have already been sold in the computer network.

The evaluation is determined in the evaluation method using at least the offer time and the object count parameter.

The system to evaluate an electronic object offered in a computer network features an evaluation unit which allows at least the following information to be determined for an offered electronic object

an offer period, which defines how long the electronic object offered has already been on offer in the computer network, and

an object count parameter which defines how many electronic objects of the same type as the offered electronic object have already been sold in the computer network.

Furthermore the evaluation unit is set up in such a way that the evaluation can at least be determined from the offer period and the object count parameter

In this case a computer network is taken to mean both computers connected via physical data links and also computers not connected by physical data links, known as “wireless networks”.

In overview the invention enables dynamic evaluation of an electronic object which is offered over a computer network, depending on dynamically changing evaluation variables (dependent variables), namely the evaluation variable (dependent variable) “offer period” and the evaluation variable (dependent variable) “object count parameter”.

Thus the invention makes it possible to evaluate non-physical objects such as information and knowledge content which in this case are present in the form of the electronic object offered.

In particular the invention allows account to be taken of the fact that evaluations of offered, electronic objects change dynamically over time, i.e. can fall as well as rise.

The individual evaluation variables can be combined by adding, multiplying or through other mathematically logical operations for evaluation.

The evaluation variables themselves change dynamically over a period, a process which can be described using a mathematical logical relationship.

On the basis of the evaluation a current price for the offered electronic object can be defined. In the most simple case the evaluation is scaled in such a way that the evaluation itself is the price.

Thus the invention also makes possible development of a dynamic billing model for chargeable access to information or knowledge in a computer network.

As a result of the dynamics, i.e. because it is possible for the price to rise as well as to fall, there can be provision for the defined price to be guaranteed as a rule only for a specified defined period.

The computer program with program code means in accordance with the invention is created to perform all steps according to the inventive evaluation method when the program is executed on a computer.

The computer program product with program code stored on a machine-readable medium is set up to perform all steps in accordance with the inventive evaluation method when the program is executed on a computer.

The system as well as the computer program with program code means, set up to perform all steps in accordance with the inventive evaluation method when the program is executed on a computer, as well as the computer program product with program code means stored on a machine-readable medium, set up to perform all steps in accordance with the inventive evaluation method when the program is executed on a computer are particularly suitable for execution of the method in accordance with the invention or of one of the developments explained below. Advantageous exemplary embodiments and further developments of the invention are specified in dependent claims.

The developments explained below relate to both the method and the system.

The invention and the developments described below can be realized in both software and hardware, for example using a special electronic circuit.

Furthermore it is possible to realize the invention or the developments described below by a computer-readable storage medium on which the computer program with program code means which executes the invention or development is stored.

The invention or each development thereof described below can be realized by a computer program product which features a storage medium on which the computer program with program code means which executes the invention is stored.

For a development further evaluation variables are taken into consideration for the electronic object offered during evaluation of this object.

Such further evaluation variables can be:

a rate of sale which specifies how many electronic objects of the same type as the electronic object offered have been sold in a specified period in the computer network and/or

a status specification for a supplier of the electronic object offered which describes the behavior of the supplier in the computer network and/or

a status specification for a possible purchaser of the electronic object offered which describes the behavior of the possible purchaser in the computer network and/or

feedback from purchasers of electronic objects of the same type as the electronic object to be offered. The status information of a supplier can for example be taken as illustrating the reputation of the supplier which reflects their trustworthiness.

The status specification of a possible purchaser can for example be taken to mean a multiple purchaser status which is assigned to a possible purchaser when the latter has already made a specified number of purchases in the computer network.

The individual evaluation variables, the originals as well as the further variables are added, multiplied or logically linked to each other for evaluation in this case using logical mathematical operations. During logical linkage the individual evaluation variables can be weighted and/or linked to each other using logical operations and/or rules.

The relationship in each case between one of the evaluation variables (dependent variables) and evaluation can be described using a specified functional relationship.

Dependencies between the evaluation variables (dependent variables) in determining the evaluation can also be taken into account.

The evaluation variables themselves change dynamically over time and this can be described in each case using a logical mathematical relationship.

Using the dynamic evaluation a current price for the offered electronic object can be defined. In the most simple case the evaluation is scaled in such a way that the evaluation itself is the price.

Because of the dynamics of the evaluation the defined price can only be guaranteed for a specified, defined period.

When the electronic object for sale is sold to a purchaser the sold electronic object offered for sale can be identified with information about the purchaser. Such identifying information be obtained from an access identification of the purchaser to the computer network or an authentication of the purchaser by the computer network or by a supplier of the electronic object for sale in the computer network.

The dynamic evaluation method is especially suited for evaluation of duplicatable objects, especially digital data and/or computer programs. Such objects of which unlimited copies can be made are often offered for sale over the Internet and/or an Intranet in the computer network, as downloadable programs for example.

### The Figures show an exemplary embodiment of the invention which is described in more detail below.

The diagrams show:

FIG. 1 a sketch describing dynamic pricing;

FIG. 2 a sketch describing how the status of a possible purchaser of an electronic object is determined;

FIG. 3 a sketch describing how a reputation for a supplier of an electronic object is determined;

FIG. 4 a sketch which describes a computer network with a server and a number of clients.

Exemplary Embodiment: Dynamic Pricing in an Electronic Internet Mall

FIG. 4 shows a computer network 400, in which a number of computers 410, 420 to 450 are interconnected via data lines 460. One computer 410 in the computer network 400 shown is a server, the other computers 420 to 450 are clients

Any data can be exchanged via the data links 460 between computers 410, 420 to 450 in computer network 400.

Internet software is installed on each of computers 410, 420 to 450 which makes possible familiar “navigiation” in the Internet, especially calling up of selected Internet addresses or downloading or interactive transfer of data from or to the Internet.

This type of installation of computers for such Internet use is generally known specialist knowledge and is not set down in any greater detail below.

On server 410 what is known as Internet mall, in the form of corresponding software is installed.

In this Internet mall software products are offered virtually to users dialing in to the computer network 400 via their relevant computers 420 to 450; they can select the desired software product from those on sale and purchase them. The software products for sale are “placed” in the Internet mall by various suppliers and a virtual sales platform is operated via this mall. In overview the Internet mall can be used like a superstore to make virtual purchases. Such virtual superstores as well as the corresponding techniques for such virtual superstores are generally known.

The software products purchased in the Internet mall are “allocated” to the relevant purchaser via a “download” over the data links 460.

The purchase price of a software product purchased is paid via a credit card payment process, whereby the purchaser has to provide their relevant credit card information when purchasing a software product. The corresponding payment techniques are also known

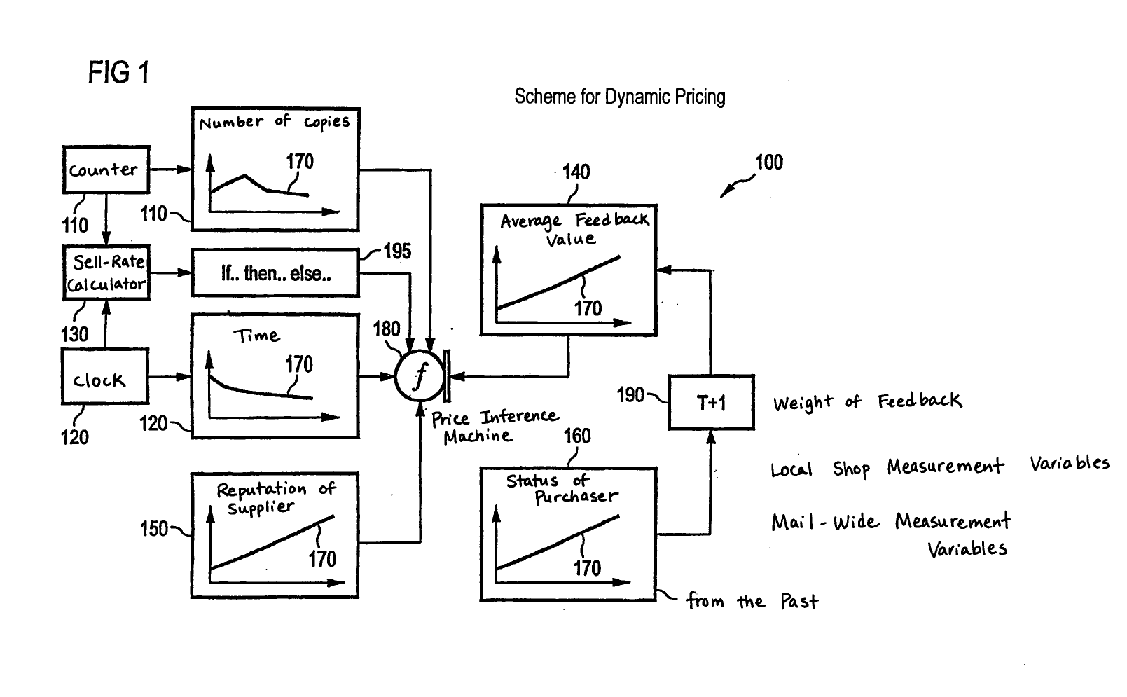

An example of pricing for a software product for sale in and obtainable from the Internet mall is explained below (FIG. 1 to FIG. 3). In this case it goes without saying that to purchase and to download the software product to be obtained, an example, in this case a copy, of the corresponding product is obtained and downloaded.

The purchase price determined by the dynamic pricing method explained below is billed to the relevant purchaser.

Dynamic Pricing

In the method for dynamic pricing 100 a number of pricing components which can each have their own parameters set are taken into account.

Their initial values are combined with the aid of algorithms and regulations and calculated into a current total price (FIG. 1).

The Individual Components are as Follows:

a) Recording the Examples or Copies of the Product 110 Sold:

These recording components for sold examples or copies 110 matter since frequently the product offered has already been sold. A relationship 170 between this number and a price amount is determined. This relationship is defined mathematically or graphically 170.

A possible relationship is: Beginning with a price of 500 euros for one example, then rising linearly to 1000 euros for 20 example, the falling linearly down to 50 euros for 1000 examples.

b) Timer 120:

Timer 120 records the elapsed time since the offer for the product was created or released.

c) Sell Rate Calculator 130:

The Sell Rate Calculator 130 determines the number of examples sold or copies per unit of time, in this case per month. In addition the percentage deviation to the previous unit of time is calculated and taken into account.

d) Feedback 140:

The feedback from purchasers is continuously recorded and statistically evaluated, whereby the average value and the variance of the feedback are two of the values determined.

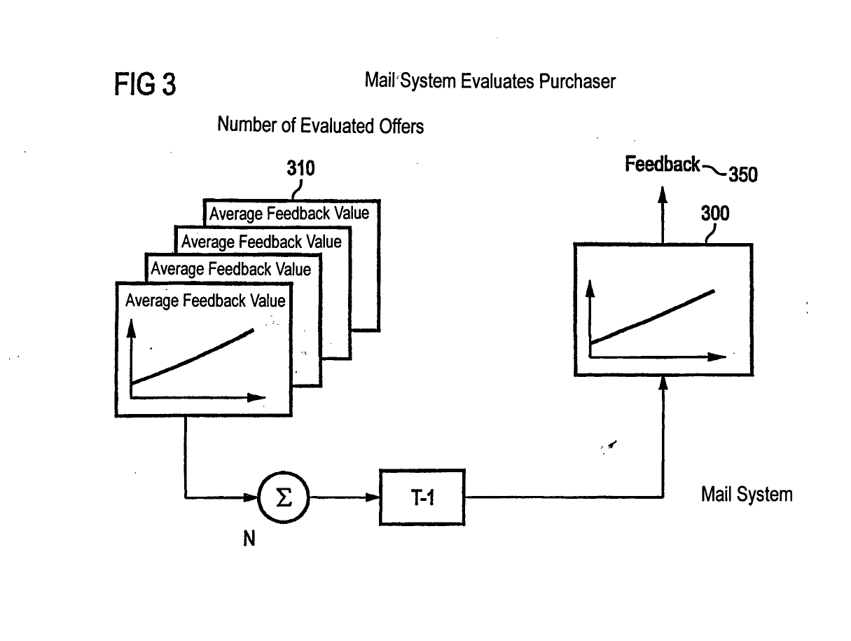

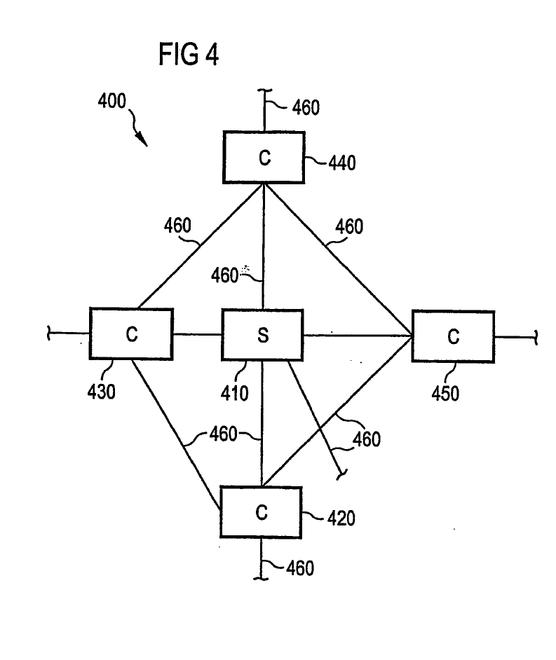

e) Reputation of the Supplier 150, FIG. 3:

The Internet mall assigns the supplier of a product a rating of their reputation 300, reflecting the supplier's trustworthiness. A rating of between 0.7 (poor) and 1.3 (outstanding) is possible.

The rating for a supplier is determined from the feedback 310 of purchasers of products from the same supplier.

Either the manufacturer themselves or an intermediary, for example a “Knowledge Broker”, can appear as supplier. For unknown suppliers or manufacturers who seldom offer anything and thus do not have a corresponding reputation, having the product supplied by a broker can be of advantage. Therefore this type of supplier looks for a broker with a good reputation who in their turn checks the quality of the unknown supplier so that they do not put their rating on the line. The broker receives a share of sales or a fixed amount for their services.

The reputation is on the one hand a marketing sign for quality and on the other hand, with a low reputation leads to withdrawal of the license to be able to offer something for sale.

The reputation also finds input 190 in the start value of the feedback components 140 which at the start contains no feedback values 350.

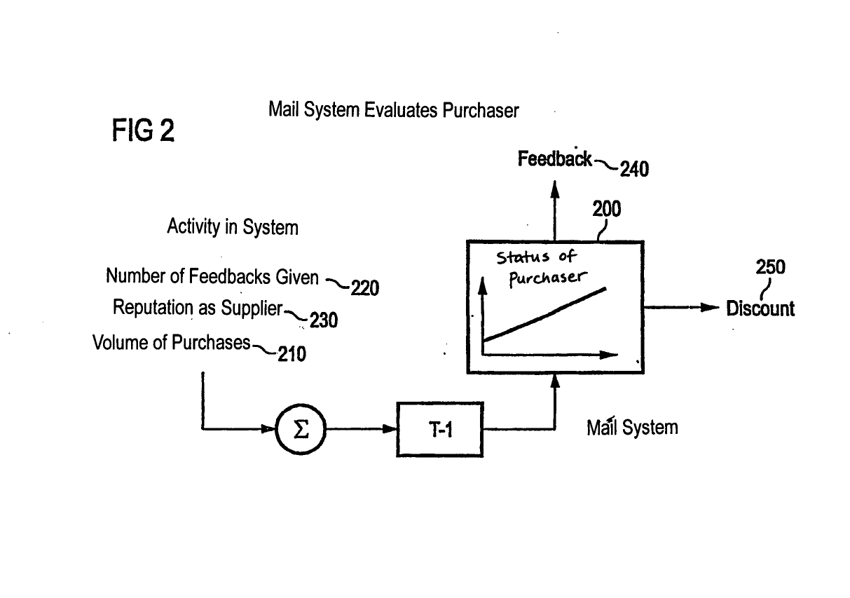

f) Status of the Purchaser 160, FIG. 2:

The status of a purchaser 200 (status values 1 to 5) depends on the previous activities of this person in the Internet mall. This includes factors such as the volume of purchases 210 which they have made in the Internet mall and the number of feedbacks 220 which they have issued.

If the purchaser is simultaneously a supplier in the Internet mall, their reputation (as supplier) also goes into the status 230.

The status of a purchaser also goes into the weighting 190 of their feedback for notifying all feedback 240. In addition the purchaser can obtain a discount as from a certain status 250, for example status 1=0% discount−Status 5=5% discount.

g) Entry of the Relative Relationships 170:

The appropriate user interfaces will be provided for entry of the relative relationships, price-time, price-feedback, price-copies, price-sell rate

h) Price Inference Machine 180:

This component 180 determines the price of the product at this moment, taking account of all relative relationships (cf. point g)). In this case the calculation includes not only figures corresponding to the relative relationships but rules are also evaluated 195, such as “provided the number sold per month does not fall the price should remain constant, then price reductions should only be made in accordance with the relative relationship between price sell rate” or “if sell rate<5 examples/month, then give an additional discount of 20% for a period of one month”.

I) Personal Watermark:

Each example or copy sold is given an individual identification containing data about the relevant purchaser. This data is available in the Internet mall and comes from the purchaser's authentication.

1. Method for evaluating an electronic object offered for sale in a computer network, in which at least the following is determined for the electronic object
an offer period, which defines how long the electronic object offered has been on offer in the computer network, and
an object count parameter which defines how many objects of the same type as the offered electronic object have already been sold in the computer network.
and for which the evaluation is at least determined depending on the offer time and the object count parameter.

2. Method according to claim 1, in which at least the following is or are further determined for the electronic object
a rate of sale which specifies how many electronic objects of the same type as the electronic object offered have been sold in a specified period in the computer network and/or
a status specification for a supplier of the electronic object offered which describes the behavior of the supplier in the computer network and/or
a status specification for a possible purchaser of the electronic object offered which describes the behavior of the possible purchaser in the computer network and/or
feedback from purchasers of electronic objects of the same type as the electronic object to be offered,
and for which the evaluation is further determined at least dependent on the purchase rate and/or the status information of the supplier and/or the status information of the possible purchaser and/or the feedback information.

3. Method in accordance with one of the previous claims, in which the evaluation is a price for the electronic object offered or a price is determined for the electronic object offered using the evaluation.

4. Procedure according to the previous claim, in which the electronic object offered is offered for a specified period in the computer network at the price determined.

5. Method in accordance with one of the previous claims, in which the dependent variables are weighted in determining the evaluation and/or combined via logical operations and/or rules.

6. Method in accordance with one of the previous claims, in which the relationships between one of the dependent variables and the evaluation are described in each case using prespecified functional relationships.

7. Method in accordance with one of the previous claims, in which the dependencies between the dependent variables are taken into account when determining the evaluation.

8. Method in accordance with one of the previous claims, in which the electronic object offered is sold to a purchaser whereby the sold electronic object is identified by a personal watermark identifying the purchaser.

9. Method in accordance with one of the previous claims, in which the electronic object offered is an object that can be duplicated any number of times, especially digital data and/or a computer program.

10. Method in accordance with one of the previous claims, in which the electronic object offered is offered via an Internet and/or an Intranet in the computer network.

11. System for evaluating an electronic object offered for sale in a computer network with an evaluation unit with which at least the following can be determined for the electronic object offered
an offer period, which defines how long the electronic object offered has been on offer in the computer network, and
an object count parameter which defines how many objects of the same type as the offered electronic object have already been sold in the computer network.
and with which the evaluation is made at least depending on the availability period and the object count parameter.

12. Computer program product that includes a computer-readable storage medium on which a program is stored which allows a computer, after the program has been loaded into the computer's memory, to execute the following steps to evaluate an electronic object offered for sale in a computer network,
a) at least the following is determined for the electronic object offered
an offer period, which defines how long the electronic object offered has been on offer in the computer network, and
an object count parameter which defines how many objects of the same type as the offered electronic object have already been sold in the computer network.
b) and the evaluation is made at least depending on the availability period and the object count parameter.

13. Computer-readable storage medium on which a program is stored which allows a computer, after the program has been loaded into the computer's memory, to execute the following steps to evaluate an electronic object offered for sale in a computer network,
a) at least the following is determined for the electronic object offered
an offer period, which defines how long the electronic object offered has been on offer in the computer network, and
an object count parameter which defines how many objects of the same type as the offered electronic object have already been sold in the computer network.
b) and the evaluation is made at least depending on the availability period and the object count parameter.

14. computer program with program code means to execute all steps in accordance with claim 1 if the program is executed on a computer.

15. computer program with program code means in accordance with claim 14 which are stored on a computer-readable data medium.

16. Computer program product with program code means stored on a machine-readable medium to perform all steps in accordance with claim 1 when the program is executed on a computer.
